(19) United States
(12) Patent Application Publication
(10) Pub. No.: US 2007/0097613 A1
(43) Pub. Date: May 3, 2007

(54) Computer display biasing mechanism

(76) Inventors: Mark S. Tracy, Tomball, TX (US); Walter J. Rankins, Spring, TX (US); Paul J. Doczy, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,288

(22) Filed: Oct. 27, 2005

(51) Int. Cl. G06F 1/16

(52) U.S. Cl. 361/683; 361/681

(57) ABSTRACT

A computer device comprises a display member coupled to a base member by at least one friction clutch hinge. The computer device also comprises a biasing mechanism spaced apart from the at least one friction clutch hinge and adapted to bias the display member away from the base member.

### BACKGROUND OF THE INVENTION

Computer devices such as notebook and laptop computers comprise a base member coupled to a display member by at least one hinge. The hinge typically comprises a friction clutch so that when opening the display member, frictional torque can be used to maintain the display at a user-selected viewing angle. However, if the computer device is new or when the display member has not been moved for a period of time, a static “break-away” torque can make it difficult to open or close the display member (e.g., requiring the use of two hands to open the computer device and/or causing the computer to tip or lift upwardly from a supporting surface). Friction clutches designed with a lower torque have been used; however, in many instances, these clutches do not adequately maintain the display member at the user-selected viewing angle. Furthermore, the lower frictional torque also increases the likelihood of damage to the device resulting from abrupt contact between the display member and the base member.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a front perspective view of a computer device, with a portion cut away, in which an embodiment of a computer display biasing mechanism in accordance with the present invention is employed to advantage;

FIG. 2 is a side view of the computer device of FIG. 1 in a closed position; and

FIG. 3 is a side view of the computer device of FIG. 1 with a display member rotated a predetermined distance with respect to a base member.

### DETAILED DESCRIPTION OF THE DRAWINGS

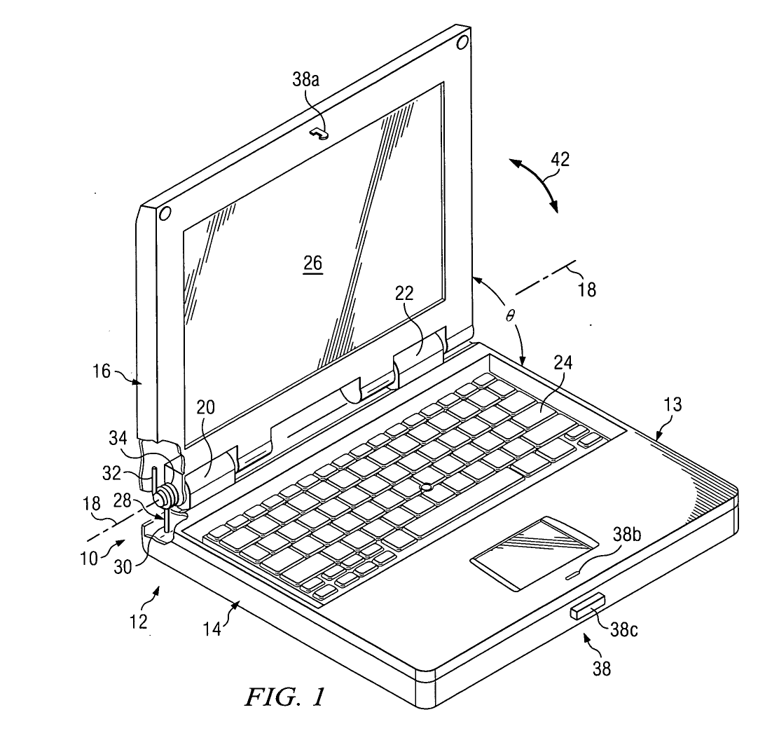

The preferred embodiments of the present invention and the advantages thereof are best understood by referring to FIGS. 1-3 of the drawings, like numerals being used for like and corresponding parts of the various drawings.

FIG. 1 is a diagram illustrating a front perspective view of a computer device 12 in which an embodiment of a biasing mechanism 10 in accordance with the present invention is employed to advantage. In the embodiment illustrated in FIG. 1, computer device 12 comprises a notebook or laptop computer 13; however, it should be understood that computer device 12 may comprise other types of computer devices such as, but not limited to, tablet personal computers and handheld computing devices. Computer device 12 comprises a base member 14 rotatably coupled to a display member 16 along an axis 18 by friction clutch hinges 20 and 22. In FIG. 1, computer device 12 is illustrated in an open position (e.g., where display member 16 is disposed generally upright relative to base member 14) at a user-selected viewing angle θ so that a user can view a display screen 26 of display member 16.

In the embodiment illustrated in FIG. 1, biasing mechanism 10 is configured to facilitate opening of computer device 12 and prevent abrupt contact between base member 14 and display member 16 when transitioning computer device 12 to the closed position (e.g., where display member 16 is disposed generally adjacent to and parallel relative to base member 14). Biasing mechanism 10 is spaced apart from and operates independently of friction clutch hinges 20 and 22. In the embodiment illustrated in FIG. 1, biasing mechanism 10 comprises a torsion spring 28; however, it should be understood that other types of mechanisms could be used for biasing mechanism 10 including, but not limited to, a clip or other type of pre-flexed member. Spring 28 comprises an end 30 couplable to base member 14, an end 32 couplable to display member 16, and a coiled portion 34 disposed therebetween. In the embodiment illustrated in FIG. 1, coiled portion 34 is disposed inside display member 16 and is coaxially aligned with an axis 18. It should be understood that in other embodiments of the present invention, coiled portion 34 may be disposed within base member 14 or, in the alternative, at a position external to either base member 14 or display member 16. Further, in the embodiment illustrated in FIG. 1, biasing mechanism 10 comprises a single spring 28; however, it should be understood that a greater number of springs 28 may be used.

In operation, display member 16 is rotatable in the directions indicated by 42 relative to base member 14. In the embodiment illustrated in FIG. 1, in response to rotational movement of display member 16 from an open position (e.g., as illustrated in FIG. 1) toward a closed position (e.g., movement of display member 16 toward base member 14), end 32 of spring 28 is rotated about axis 18 toward end 30 of spring 28, thereby storing potential energy via coiled portion 34, resisting the rotational movement of display member 16 toward base member 14, and substantially reducing or eliminating the likelihood of display member 16 abruptly contacting base member 14. A locking mechanism 38 is used to releasably secure display member 16 to base member 14, thereby retaining the stored potential energy in spring 28. In the embodiment illustrated in FIG. 1, locking mechanism 38 comprises a hook 38a for insertion inside recessed area 38b so as to engage a latch 38c.

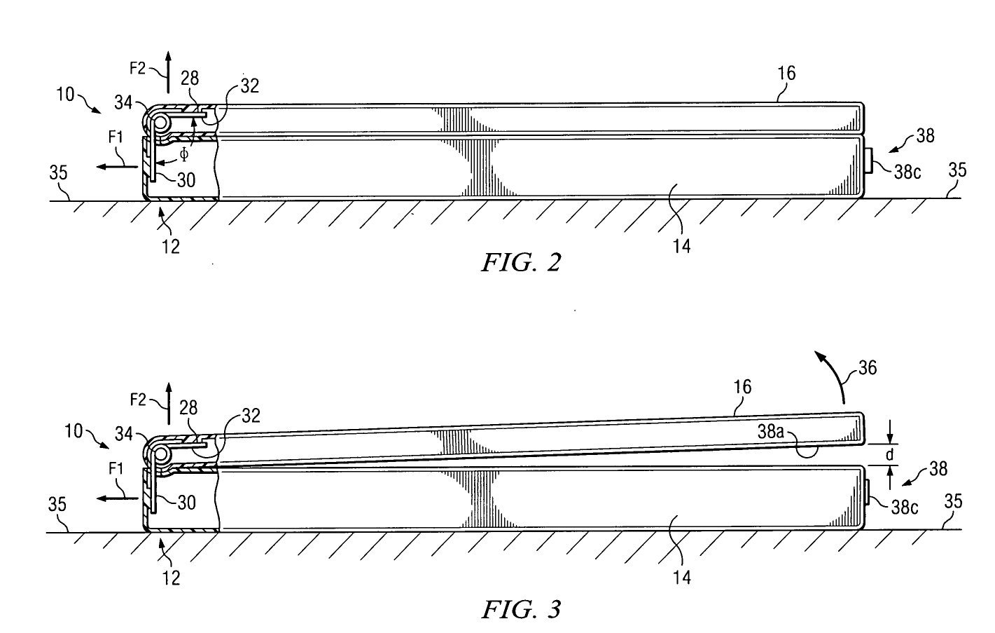

FIG. 2 is a side view of the of the computer device 12 of FIG. 1 in the closed position and positioned on a support surface 35. In the embodiment illustrated in FIG. 2, end 32 of torsion spring 28 is positioned at an angle Φ relative to end 30 such that the potential energy stored in spring 28 causes ends 30 and 32 of torsion spring 28 to exert forces F1 and F2 on base member 14 and display member 16, respectively.

FIG. 3 is a side view of the computer device 12 of FIG. 1 with display member 16 separated/lifted/rotated a predetermined distance “d” from base member 14. In the embodiment illustrated in FIG. 3, locking mechanism 38 has been actuated and/or otherwise released to facilitate opening of display member 16 relative to base member 14. In response to the actuation and/or release of locking mechanism 38, forces F1 and F2 stored by spring 38 overcome a weight of display member 16 and/or the torque associated with friction clutch hinges 20 and 22, thereby causing display member 16 to automatically rotate/lift in the direction of arrow 36 a predetermined distance “d” relative to base member 14 to facilitate opening of display member 16 by a user. The user may then further open (rotate) display member 16 to a desired viewing angle θ relative to base member 14 (FIG. 1).

Thus, embodiments of the present invention provide a biasing mechanism 10 for a computer device 12 that automatically separates and/or lifts display member 16 a predetermined distance from base member 14 to facilitate opening thereof by a user. Accordingly, embodiments of the present invention facilitate opening of display member 16 relative to base member 14 without the use of two hands by the user. Further, embodiments of the present invention provide protection against abrupt and/or unintentional contact between base member 14 and display member 16 which may otherwise cause damage to base member 14, display member 16 and/or display screen 26.

What is claimed is:

1. A computer device, comprising:
a display member coupled to a base member by at least one friction clutch hinge; and
a biasing mechanism spaced apart from the at least one friction clutch hinge, the biasing mechanism adapted to bias the display member away from the base member.

2. The computer device of claim 1, wherein the biasing mechanism comprises a coiled portion coaxially aligned along an axis of the at least one friction clutch hinge.

3. The computer device of claim 1, wherein the biasing mechanism comprises a coiled portion disposed in the display member.

4. The computer device of claim 1, wherein the biasing mechanism is configured to resist rotational movement of the display member toward the base member.

5. The computer device of claim 1, wherein the biasing mechanism is a torsion spring.

6. A computer device, comprising:
a display member coupled to a base member by at least one friction clutch hinge; and
a biasing mechanism operationally independent from the at least one friction clutch hinge, the biasing mechanism configured to resist rotational movement of the display member toward the base member.

7. The computer device of claim 6, wherein the biasing mechanism comprises a coiled portion coaxially aligned along an axis of the at least one friction clutch hinge.

8. The computer device of claim 6, wherein the biasing mechanism comprises a coiled portion disposed in the display member.

9. The computer device of claim 6, wherein the biasing mechanism is a torsion spring.

10. A computer device, comprising:
means, operationally independent of at least one friction clutch hinge coupling a display member to a base member, for biasing the display member away from the base member.

11. The computer device of claim 10, wherein the basing means is at least partially coaxially aligned with the at least one friction clutch.

12. The computer device of claim 10, wherein the biasing means comprises means for resisting rotation of the display member toward the base member.

13. The computer device of claim 10, wherein the biasing means comprises a torsion spring.

14. A method of manufacturing a computer device, comprising:
providing a display member coupled to a base member by at least one friction clutch hinge; and
providing a biasing mechanism operationally independent from the at least one friction clutch hinge for biasing the display member away from the base member.

15. The method of claim 14, further comprising coaxially aligning at least a portion of the biasing mechanism with the at least one friction clutch hinge.

16. The method of claim 14, further comprising disposing a coiled portion of the biasing mechanism within the display member.

17. The method of claim 14, wherein providing a biasing mechanism comprises providing a torsion spring.

18. A computer device, comprising:
a display member coupled to a base member by at least one friction clutch hinge; and
a biasing mechanism operationally independent of the at least one friction clutch hinge for biasing the display member away from the base member.

19. The computer device of claim 18, wherein the biasing mechanism comprises a coiled portion coaxially aligned with an axis of the at least one friction clutch hinge.

20. The computer device of claim 18, wherein the biasing mechanism comprises a coiled portion disposed in the display member.

21. The computer device of claim 18, wherein the biasing mechanism resists rotational movement of the display member toward the base member.

22. The computer device of claim 18, wherein the biasing mechanism is configured to automatically rotate the display member relative to the base member in response to releasing the display member from a closed position relative to the base member.
